(19) United States
(12) Patent Application Publication
(10) Pub. No.: US 2020/0193393 A1
(43) Pub. Date: Jun. 18, 2020

(54) A SYSTEM AND A METHOD FOR CREATION, ISSUANCE, CONTINUOUS RECALCULATION AND CIRCULATION OF MULTIPLE PURPOSE ALGORITHMICALLY REGULATED ELECTRONICALLY ENCRYPTED MEANS

(71) Applicant: Maris Ralfs MUNDI, Riga (LV)

(72) Inventor: Maris Ralfs MUNDI, Riga (LV)

(21) Appl. No.: 16/641,258

(22) PCT Filed: Aug. 28, 2018
(86) PCT No.: PCT/IB2018/056543

§ 371 Date: Feb. 24, 2020

(30) Foreign Application Priority Data
Aug. 29, 2017 (IB) PCT/IB2017/055171

(51) Int. Cl. G06Q 20/02; G06Q 20/06

(52) U.S. Cl. CPC G06Q 20/027; G06Q 2220/00; G06Q 20/0655; G06Q 20/0652

(57) ABSTRACT

Invention relates to systems and methods for creation, issuance and continuous recalculation of multiple purpose algorithmically regulated electronically encrypted means; electronic instruments and techniques of bilateral and multilateral exchanges-resultant-obligations settlement governed by at all times accessible and transparent and unambiguously defined digital protocols. The system further comprises four main elements of the system: a central EnAEMs (multiple purpose algorithmically regulated electronically encrypted means) issuance device, group control units connected to the, user devices connected to the EnAEMs issuance device and to one of the group control units, and accrual generating asset pool connected to the EnAEMs issuance device.

### FIELD OF THE INVENTION

Invention relates to systems and methods for creation, issuance and continuous recalculation of multiple purpose algorithmically regulated electronically encrypted means; electronic instruments and techniques of bilateral and multilateral exchanges-resultant-obligations settlement governed by at all times accessible and transparent and unambiguously defined digital protocols. The present invention seeks to solve several problems in the prior art.

### BACKGROUND OF THE INVENTION

United States patent application No. US 2010/0217710 discloses an electronic money system comprising a management server, a verification server, a remittance terminal, and a receptor terminal. This is typical electronic money system which resembles physical currency system.

United States patent application No. US 2013/0346164 discloses a peer-to-peer currency platform and method incorporating demurrage. The method includes providing, through an agent executing on a computing platform at a data processing device, a capability to a user of the data processing device to form a group of members. Each of the members is associated with a data processing device coupled to the data processing device forming the group. Further, the method includes recording currency transactions within the group through a currency server and implementing demurrage on the currency to incentivize quick spending on part of the members International patent application publication No. WO 2017/132450 discloses an apparatus, computer-readable medium, and computer-implemented method for creating collateralized portfolios. A portfolio is a collection of income-producing assets. These income-producing assets are a derivative of primary sources such as real property. A portfolio is generated through transactions that exchange estimated asset value for liquid instruments in the portfolio. Asset valuation is determined through known pricing functions. Each portfolio's reservoir is collectively owned by the shareholders; continuously replenishing itself with income generated by assets in the portfolio. Shares can be represented by digital tokens, traded as digital currency such as cryptocurrency, and monetized with the convenience of cash through a network of exchanges and payment gateways.

Well known prior art discloses bailment contracts regarding non-income-producing assets (e.g. precious-metals-standard), large group qualified solidary liability agreements (fiat currencies), and crypto currencies.

After analysis of the existing proposals and implementations one may conclude that prior art so far has not produced a satisfactory system.

The following are some of the shortcomings of systems and methods practiced in prior art:
does not represent solidary obligation of a defined group of individuals e.g., citizens of a nation state (precious-metals-standard and crypto currencies); and
is not an agreement (crypto currencies);
mechanisms of new-units-creation and circulation provision itself increase in cost over time (crypto currencies);
does not address velocity of exchanges-resultant-obligations settlement problem (all systems and methods in prior art);
does not provide transparent data on total units in existence and mechanisms of new-units-creation (fiat currencies);
usability subject to volatility caused by a) cultural changes, i.e. one might not need precious metals, but always shall need debt by others, b) scientific advances in providing alternatives, c) increased supply or lack thereof (precious-metals-standard). For illustrative purposes a table (Table 1) disclosing shortcomings of prior art is gives below.

TABLE 1
Comparison analysis of present invention vs prior-art.

| | | | Bailment contract | | | | |
|---|---|---|---|---|---|---|---|
| | | | for non-income | | | | |
| | | | producing assets | | | | |
| | Present | Crypto | (e.g. “precious | Fiat | | | |
| | Invention | currencies | metals standard”) | currencies | US2013346164 | WO2017132450 | US2010217710 |
| Can the system and method | YES | YES | NO | NO | YES | YES | YES |
| operate within smart/digital | | | | | | | |
| contracts/agreements | | | | | | | |
| protocols? | | | | | | | |
| Does the system and method | YES | YES | N/A | NO | NO | N/A | NO |
| provide transparent and | | | | | | | |
| complete data on total | | | | | | | |
| number of existing units? | | | | | | | |
| Are mechanisms of new-units- | YES | YES | N/A | NO | NO | YES | NO |
| creation and deletion well | | | | | | | |
| defined? Is creation of new | | | | | | | |
| units limited by an algorithm/ | | | | | | | |
| formula? | | | | | | | |
| Does the system and method | YES | NO | YES | NO | NO | YES | NO |
| provide multiple-application | | | | | | | |
| possibilities, multiple means | | | | | | | |
| of use for the units in | | | | | | | |
| circulation? | | | | | | | |
| Is the system and method | YES | NO | N/A | YES | NO | NO | NO |
| valid solidary obligation of a | | | | | | | |
| defined group of users where | | | | | | | |
| set-off by unit transfer is | | | | | | | |
| possible? | | | | | | | |
| Are automated digital | YES | N/A | NO | NO | NO | YES | NO |
| contracts possible whereby | | | | | | | |
| units can be used as transfer- | | | | | | | |
| obligation-supporting- | | | | | | | |
| collateral within the system | | | | | | | |
| and method? | | | | | | | |
| Is there a protocol to link | YES | N/A | NO | NO | NO | NO | NO |
| 3rd party modules to the system | | | | | | | |
| for security, encryption and | | | | | | | |
| verification purposes? | | | | | | | |
| Does the system and method | YES | NO | NO | NO | YES | NO | NO |
| solve obligation-settlement- | | | | | | | |
| means velocity (sluggish | | | | | | | |
| money velocity) problem? | | | | | | | |
| Is the creation of new units | YES | NO | NO | NO | NO | YES | N/A |
| subordinated to benefit UDs | | | | | | | |
| connected to the system | | | | | | | |
| per set algorithm? | | | | | | | |

### SUMMARY OF THE INVENTION

The present invention is a multiple purpose algorithmically regulated electronically encrypted means, it combines transparent and at all-times accessible data, formulas, resource-economical encryption and verification and can be used in one of its several electronic forms per choice of user.

The present invention is a system and a method for creation, issuance and continuous recalculation of multiple purpose algorithmically regulated electronically encrypted means (hereinafter “EnAEM”) and provision of circulation platform for EnAEM.

The EnAEMs can take only one of forms at any given time and whereby transformation among means-forms is allowed only under mathematical algorithms as defined by the central control unit (hereinafter “CCU”) and contained within groundwork of central data base (hereinafter “CDB”), whereby digital agreements and smart contracts provision and regulate bulk of exchanges and transfers of EnAEMs between and among user devices (hereinafter “UDs”). The digital agreements and smart contracts are digital protocols that digitally facilitate, verify, and enforce transactions.

A user of the UD can select one of the forms of EnEAMs allotted to user's UD from the following:

1) obligation settlement or exchange means, where numerical value of said means is a function of passing time (hereinafter “TDC”);

2) proportional rights within defined income generating asset pool (hereinafter “IGAPP”); or

3) advance issuance among LIG members based on digital or smart agreements, wherein the IGAPP rights automatically serve as a potentially TDCAcc generating collateral.

The system comprises from three main elements—a central EnAEMs issuance device (hereinafter “EID”), a group control units (hereinafter “GCUs”) linked to the EID, and the UDs. The system further comprises a TDC accrual per IGAPP (hereinafter “TDCAcc”) generating asset pool (hereinafter “IGAP”).

The system further comprises a limited-maximum-participating-UD-number internal group (hereinafter “LIG”) formation and operation is permitted, Each UD is allowed to be a participant to a limited number of the LIGs. The LIG mainly comprises at least one GCU and associated to said GCU UDs. The system may comprise the LIG/-s in a range of 1 to 3 and the LIG-constituent-UDs in a range of 2 to 200.

The EID further comprises a central data base (hereinafter “CDB”). The CDB is configured to: store an information on the number of the UDs linked to the EID at any given time; store and implement regulations of the new UDs linking to the EID, thus, becoming participants in the system described herein; store an information on the number of TDC units (hereinafter “TDCs”) issued, recalculated or deleted at any given time, and total nominal sum of EnAEM in circulation; store imbedded foundational algorithms, formulas and functions regarding recalculation of nominal value of each EnAEM at any given time; and store IGAPP control and rights sharing, and TDC accrual per IGAPP (hereinafter “TDCAcc”) and allotted to individual UDs distribution and calculation module, as defined and characterized in an asset pool module (hereinafter “APM”).

The EID further comprises central control unit (hereinafter “CCU”) connected to the CDB and configured to perform calculations in line with CDB algorithms and formulas and to set and recalculate particular taken form for all EnAEMs and numerical values of all TDCs in circulation.

The CCU is further configured to calculate total number of TDCs in circulation at any chosen moment of time according to the following equation:

X=(N_{UD*}Y)+Z_{exceptions}+(K*Hc) (1)

where

X is the total number of TDCs in circulation,

N_{UD} is a number of the viable UD linked to the system,

Y is a positive integer,

Z_{exceptions} is a) initial EnAEMs issued before the UDs are operational plus b) allocated reserve EnAEMs according to the CDB algorithms, and

K total numerical value of IGAP constituents and He is a coefficient—a positive real number in the range of 0.01 to 2.9.

Said calculation of total number of TDCs in circulation is performed by the system at any chosen moment of time.

The system further comprises an EnAEM generator (hereinafter “EG”) configured to generate new EnAEMs according to data exchange with the CCU and the CDB.

The system further comprises a time stamp generator (hereinafter “TSG”) connected to the CCU and configured to generate, encrypt and assign a digital time stamp to generated EnAEMs;

The system further comprises EnAEM transfer unit (hereinafter “ETU”) configured to transfer the EnAEMs to designated group control unit (GCU) and/or to the UD, per instructions by the CDB and/or the CCU;

The GCU comprises four main elements: a group control unit data base (hereinafter “CUDB”), a group control unit processor (hereinafter “CUP”), a transaction receiver (hereinafter “TR”) and a transaction executor (hereinafter “TE”).

The CUDB stores data on, inter alias, users (UDs) of the system that are members of the respective LIG; data on EnAEMs transactions between the LIG UDs; and is further configured to provide and exchange the above data with the EID.

The CUP is configured to perform calculations in accordance with algorithms set by the EID and further configured to calculate internal rights proportions, EnAEMs exchange and TDCAcc, wherein where EnAEMs exchange among the UDs of LIG is incentivized by very low or zero transaction cost;

The TR is configured to receive a request on EnAEMs transfer from one UD to another UD and to update respective information in both UDs participating in a transaction;

The TE is configured to receive a transaction execution request from the TR; perform the check on EnAEM sufficiency of the UD requesting transaction and executing said transaction by sending the defined EnAEMs to receiver that is another UD.

The UD comprises a memory unit; a processor and an interface, wherein each UD is connected to either EID or its sub-modules, and to a GCU, if UD has chosen LIG membership option.

The IGAP further comprises an asset pool module (hereinafter “APM”) configured to perform the following operations or procedures:
defining the underlying TDCAcc generating assets and transparently displaying said data to all UDs,
transferring TDCAcc for all viable UDs according to proportional rights share (hereinafter “IGAPP”) of each individual UD; and
implementing mandatory distribution of TDCAcc from the IGAP to the EID.

The total number of EnAEMs is a factor of the UDs linked to the system and total numerical value of the IGAP constituents. A total number of EnAEMs generated by the method is a factor of the UDs linked to the system and total numerical value of the IGAP constituents.

The APM is further configured to allocate TDCAcc either a) in form of TDCs directly or b) in form of any digital tokens, crypto currencies or fiat currencies, where in the case of b) further transformation into EnAEMs takes place according to CDB algorithms and subsequent distribution among UDs according to IGAPP as described herein.

The EID further comprises a history database (hereinafter “HDB”) connected to the CCU and configured to store data on actions of the CCU as well as providing empirical analysis of stored data and suggestions for potential algorithm improvements.

The system further comprises a physical currency issuer (hereinafter “PCI”) connected to the EID and configured to issue physical currency that correlates to the EnAEMs, wherein the PCI further comprises a physical time stamp generator for recording exact time of physical EnAEM issue and its expiration date.

The TDC may be a physical TDC comprising a RFID (Radio-frequency identification) or a NFC (Near Field Communication) chip for identification of a time stamp issued by a time stamp generator of the EID.

The TDC may be printed in physical paper-based form with a time stamp issued by a time stamp generator (TSG) of the EnAEM issuance device (EID).

The system further comprises a 3rd party oversight and smart contracts' dispute resolution module (hereinafter “3rdMod”).

The present invention is also a method of operating aforementioned system The method comprises the following steps:

a) creation of multiple purpose algorithmically regulated electronically encrypted means (ENAEMs) in a EnAEM generator (EG) of a EnAEM issuance device (EID) in an amount specified by a central control unit (CCU) configured to calculate the permitted amount of the ENAEMs based on algorithms, formulas and data stored in the central data base (CDB);

b) transfer of the newly generated EnAEMs to a designated central control unit (CCU) via EnAEM transfer unit (ETU), wherein the ETU is configured to receive data and process transfer amount of the ENAEMs from the CDB via the CCU;

c) transferring of EnAEMs to designated user devices (UDs) and provisioning of a platform for transfer of EnAEMs among the UDs per users' instructions;

d) registration of a time period of EnAEMs issuance and storage in particular UDs and registration of the UDs' instructions regarding selection of permitted forms of EnAEMs;

e) continuous re-calculation by the CCU of numerical value of numerical value of said means is a function of passing time (hereinafter “TDC”) based on a predetermined algorithm including degradation coefficient and transfer cost;

f) continuous re-calculation by the CCU of proportional rights within defined income generating asset pool (hereinafter “IGAPP”) distribution among the UDs;

g) distribution of TDC accrual per IGAPP (hereinafter “TDCAcc”) among the UDs according to IGAPP proportion of each UD;

h) distribution of TDCAcc per IGAPP if and when used as collateral for securing LIG or inter-group advances among UDs;

i) defining the underlying IGAP for TDCAcc generation and transparently displaying said data to all viable UDs via common real-time dashboard or otherwise as requested by the UD; and

j) implementing mandatory distribution of TDCAcc from the IGAP to the EID.

As a continuous function of passing time the EID and/or the CCU re-calculates numerical value of TDCs in circulation according to pre-set time-dependant-degradation-coefficient.

The EnAEMs acquire additional means-forms for UDs to choose in addition to the ones defined herein per merging and accumulating of lesser encrypted or secured protocols and assets.

### BRIEF DESCRIPTION OF THE DRAWINGS

The following disclosure will be better understood by a person skilled in the art when read in conjunction with the FIGURE.

FIG. 1 illustrates a schematic of a system for creation, issuance, circulation and continuous recalculation and circulation of multiple purpose algorithmically regulated electronically encrypted means.

### DETAILED DESCRIPTION OF THE INVENTION

Before explaining the disclosed embodiment of the present invention in detail, it is to be understood that the invention is not limited in its application to the details of the particular arrangements shown, since the invention is capable of other embodiments. Also, the terminology used herein is for the purpose of description and not of limitation.

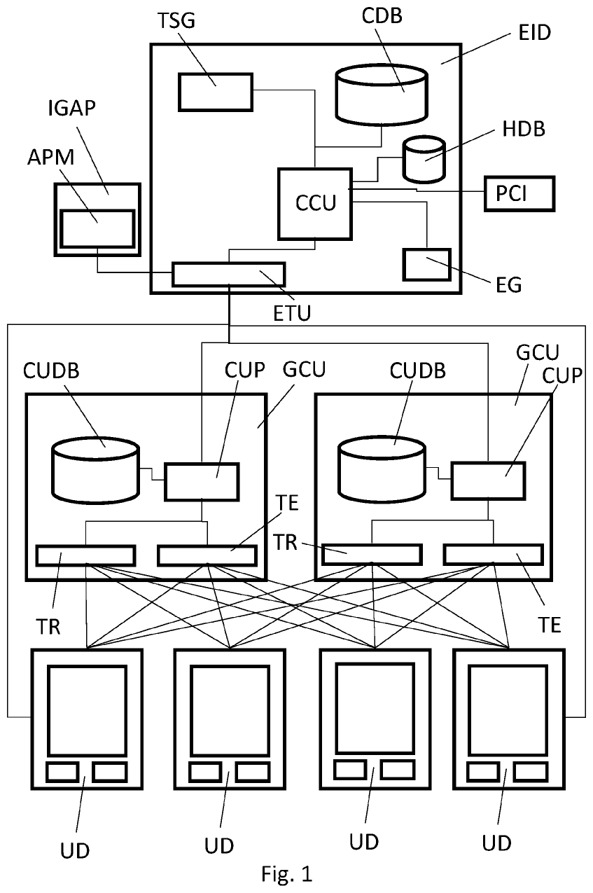

FIG. 1 illustrates a system for creation, issuance, circulation and continuous recalculation of multiple purpose algorithmically regulated electronically encrypted means (hereinafter “EnAEM”) and provision of circulation platform for EnAEM. The EnAEMs can take only one of forms at any given time and whereby transformation among means-forms is allowed only under mathematical algorithms as defined by the central control unit CCU and contained within groundwork of central data base CDB. The system further comprises four main elements of the system: a central EnAEMs issuance device EID, group control units GCU connected to the EID, user devices UDs connected to the EID and to the GCU, and accrual generating asset pool IGAP connected to the EID. Accrual is time degradable currency (hereinafter “TDC”) accrual per IGAPP and allotted to individual UD. The IGAPP is proportional rights within defined income generating asset pool.

The members of the system that are illustrated in FIG. 1 are set in “Bold” within this application.

The EID comprises a central data base CDB. The CDB is configured to store an information on the number of the UDs linked to the EID at any given time. The CDB stores and implements regulations on the new UDs linking to the EID, thus, becoming participants in the system described herein.

The CDB stores an information on the number of TDC units issued, recalculated or deleted at any given time, and total nominal sum of EnAEM in circulation. The CDB also stores imbedded foundational algorithms, formulas and functions regarding recalculation of nominal value of each EnAEM at any given time, as well as stores IGAPP control and rights sharing, and TDC accrual per IGAPP and allotted to individual UDSs (hereinafter “TDCAcc”) distribution and calculation module, as defined and characterized in an asset pool module APM.

The CCU is connected to the CDB and configured to perform calculations in line with the CDB algorithms and formulas and to set and recalculate numerical values of EnAEMs.

The EID further comprises an EnAEM generator EG configured to generate new EnAEMs according to data exchange with the CCU and the CDB. The EID further comprises a time stamp generator TSG connected to the CCU and configured to generate, encrypt and assign a digital time stamp to generated EnAEMs. The EID further comprises EnAEM transfer unit ETU connected to the CCU and the GCU. The ETU is configured to transfer the EnAEMs to designated GCU and/or to the UD, per instructions by the CDB and/or the CCU. The EID further comprises a history data base HDB connected to the CCU and configured to store data on actions of the CCU as well as providing empirical analysis of stored data and suggestions for potential algorithm improvements.

The GCU is linked to the EID. In present embodiment (see FIG. 1) the system comprises two GCU where each GCU is connected to the ETU of the EID. The GCU comprises a group control unit processor CUP, a group control unit data base CUDB connected to the GCU, a transaction receiver TR connected to the GCU and a transaction executor TE connected to the GCU.

The CUDB comprises data on, inter alias, UDs of the system that are members of the respective limited-maximum-participating-UD-number internal group (hereinafter “LIG”). The LIG consists of one GCU and several associated UDs. In present embodiment each LIG comprises one GCU and four UDs. The number of the UDs within the LIG may be set according to the predefined protocols of the system. The CUDB further comprises data on EnAEMs transactions between the UDs of the LIG. The CUDB is further configured to provide and exchange the above data with the EID.

The CUP is configured to perform calculations in accordance with algorithms set by the EID and further configured to calculate internal rights proportions, EnAEMs exchange and TDCAcc. The EnAEMs exchange among the UDs of the LIG is incentivized by very low or zero (no) transaction cost.

The TR is configured to receive a request on EnAEMs transfer from one UD to another UD and to update respective information in both UDs participating in a transaction.

The TE is configured to receive a transaction execution request from the TR, perform the check on EnAEM sufficiency of the UD requesting transaction and executing said transaction by sending the defined EnAEMs to receiver that is another UD.

The UD comprises a memory unit; a processor and an interface. Each UD is connected to either EID or its sub-modules, and to a GCU, if UD has chosen LIG membership option.

The system further comprises TDCAcc generating asset pool IGAP. The IGAP further comprises an asset pool module APM configured to perform the following operations or procedures: defining the underlying TDCAcc generating assets and transparently displaying said data to all UDs, transferring TDCAcc for all viable UDs according to the IGAPPs of each individual UD; and implementing mandatory distribution of TDCAcc from the IGAP to the EID.

The system further comprises a physical currency issuer PCI connected to the CCU of the EID and the PCI is configured to issue physical currency that correlates to the EnAEMs. The PCI further comprises a physical time stamp generator for recording exact time of physical EnAEM issue and its expiration date.

The invention has been described with reference to various specific and illustrative embodiments and techniques. However, one skilled in the art will recognize that many variations and modifications may be made while remaining within the scope of the invention as defined in the appended claims.

### LIST OF REFERENCES

EnAEM—an algorithmically regulated electronically encrypted multi-purpose means;
TDC—obligation settlement or exchange means, where nominal (numerical) value of said means is a function of passing time;
LIG—limited internal group;
IGAP—income generating asset pool;
IGAPP—proportional rights within the IGAP;
APM—IGAPP control and rights sharing, recalculation, income distribution module
TDCAcc—TDC accrual per IGAPP and allotted to individual UDs;
EID—EnAEM issuance device;
CDB—central data base;
CCU central control unit;
EG EnAEM generator;
TSG—time stamp generator;
ETU—EnAEM transfer unit;
HDB—history data base;
PCI—physical EnAEM generator;
GCU—group control unit;
CUDB—group control unit data base;
CUP—group control unit processor;
TR transaction receiver;
TE—transaction executor; and
UD—user device.

1. A system for creation, issuance and continuous recalculation of multiple purpose algorithmically regulated electronically encrypted means (hereinafter “EnAEM”) and provision of circulation platform for EnAEM, wherein said EnAEMs can take only one of forms at any given time and whereby transformation among means-forms is allowed only under mathematical algorithms as defined by the central control unit (hereinafter “CCU”) and contained within groundwork of central data base (hereinafter “CDB”), whereby digital agreements and smart contracts provision and regulate bulk of exchanges and transfers of EnAEMs between and among user devices (hereinafter “UDs”), wherein limited-maximum-participating-UD-number internal group (hereinafter “LIG”) formation and operation is permitted, whereby each UD is allowed to be a participant to a limited number of the LIGs; wherein the system comprises:
a central EnAEMs issuance device (hereinafter “EID”), wherein the EID further comprises:
a central data base (hereinafter “CDB”) configured to:
store an information on the number of the UDs linked to the EID at any given time;
store and implement regulations of the new UDs linking to the EID, thus, becoming participants in the system described herein;
store an information on the number of TDC units (hereinafter “TDCs”) issued, recalculated or deleted at any given time, and total nominal sum of EnAEM in circulation;
store imbedded foundational algorithms, formulas and functions regarding recalculation of nominal value of each EnAEM at any given time;
store IGAPP control and rights sharing, and TDC accrual per IGAPP (hereinafter “TDCAcc”) and allotted to individual UDs distribution and calculation module, as defined and characterized in an asset pool module (hereinafter “APM”);
a central control unit (hereinafter “CCU”) connected to the CDB and configured to perform calculations in line with CDB algorithms and formulas and to set and recalculate particular taken form for all EnAEMs and numerical values of all TDCs in circulation;
EnAEM generator (hereinafter “EG”) configured to generate new EnAEMs according to data exchange with the CCU and the CDB;
a time stamp generator (hereinafter “TSG”) connected to the CCU and configured to generate, encrypt and assign a digital time stamp to generated EnAEMs;
EnAEM transfer unit (hereinafter “ETU”) configured to transfer the EnAEMs to designated group control unit (GCU) and/or to the UD, per instructions by the CDB and/or the CCU;
group control units (hereinafter “GCUs”) linked to the EID, wherein a GCU comprises:
a group control unit data base (hereinafter “CUDB”) comprising data on, inter alias, users (UDs) of the system that are members of the respective LIG; data on EnAEMs transactions between the LIG UDs; and is further configured to provide and exchange the above data with the EID;
a group control unit processor (hereinafter “CUP”) configured to perform calculations in accordance with algorithms set by the EID and further configured to calculate internal rights proportions, EnAEMs exchange and TDCAcc, wherein where EnAEMs exchange among the UDs of LIG is incentivized by very low or zero transaction cost;
a transaction receiver (hereinafter “TR”) configured to receive a request on EnAEMs transfer from one UD to another UD and to update respective information in both UDs participating in a transaction;
a transaction executor (hereinafter “TE”) configured to receive a transaction execution request from the TR; perform the check on EnAEM sufficiency of the UD requesting transaction and executing said transaction by sending the defined EnAEMs to receiver that is another UD;
and
wherein the UD comprises a memory unit; a processor and an interface, wherein each UD is connected to either EID or its sub-modules, and to a GCU, if UD has chosen LIG membership option;
wherein the system further comprises TDCAcc generating asset pool (hereinafter “IGAP”), wherein the IGAP further comprises an asset pool module (hereinafter “APM”) configured to perform the following operations or procedures:
defining the underlying TDCAcc generating assets and transparently displaying said data to all UDs,
transferring TDCAcc for all viable UDs according to proportional rights share (hereinafter “IGAPP”) of each individual UD; and
implementing mandatory distribution of TDCAcc from the IGAP to the EID.

2. The system according to the claim 1, wherein a user of the UD can select one of the forms of EnEAMs allotted to user's UD from the following: 1) obligation settlement or exchange means, where numerical value of said means is a function of passing time (hereinafter “TDC”) or 2) proportional rights within defined income generating asset pool (hereinafter “IGAPP”) or 3) advance issuance among LIG members based on digital or smart agreements, wherein the IGAPP rights automatically serve as a potentially TDCAcc generating collateral.

3. The system according to claim 1 wherein total number of EnAEMs is a factor of the UDs linked to the system and total numerical value of the IGAP constituents.

4. The system according to claim 1, wherein the CCU is further configured to calculate total number of TDCs in circulation at any chosen moment of time according to the following equation:
X=(N_{UD}*Y)+Z_{exceptions}+(K*Hc) (1)
where
X is the total number of TDCs in circulation,
N_{UD} is a number of the viable UD linked to the system,
Y is a positive integer,
Z_{exceptions} is a) initial EnAEMs issued before the UDs are operational plus b) allocated reserve EnAEMs according to the CDB algorithms, and
K total numerical value of IGAP constituents and He is a coefficient—a positive real number in the range of 0.01 to 2.9.

5. The system according to claim 1, wherein the APM is further configured to allocate TDCAcc either a) in form of TDCs directly or b) in form of any digital tokens, crypto currencies or fiat currencies, where in the case of b) further transformation into EnAEMs takes place according to CDB algorithms and subsequent distribution among UDs according to IGAPP as described herein.

6. The system according to claim 1, wherein the EID further comprises a history data base (hereinafter “HDB”) connected to the CCU and configured to store data on actions of the CCU as well as providing empirical analysis of stored data and suggestions for potential algorithm improvements.

7. The system according to claim 1, wherein the system further comprises a physical currency issuer (hereinafter “PCI”) connected to the EID and configured to issue physical currency that correlates to the EnAEMs, wherein the PCI further comprises a physical time stamp generator for recording exact time of physical EnAEM issue and its expiration date.

8. The system according to claim 1, wherein the system further comprises a 3rd party oversight and smart contracts' dispute resolution module (hereinafter “3rdMod”).

9. The system according to claim 1, wherein the system comprises the LIG/-s in a range of 1 to 3 and the LIG-constituent-UDs in a range of 2 to 200.

10. A method of operating a system according to claim 1, wherein the method comprises the following steps:
a) creation of multiple purpose algorithmically regulated electronically encrypted means (ENAEMs) in a EnAEM generator (EG) of a EnAEM issuance device (EID) in an amount specified by a central control unit (CCU) configured to calculate the permitted amount of the ENAEMs based on algorithms, formulas and data stored in the central data base (CDB);
b) transfer of the newly generated EnAEMs to a designated central control unit (CCU) via EnAEM transfer unit (ETU), wherein the ETU is configured to receive data and process transfer amount of the ENAEMs from the CDB via the CCU;
c) transferring of EnAEMs to designated user devices (UDs) and provisioning of a platform for transfer of EnAEMs among the UDs per users' instructions;
d) registration of a time period of EnAEMs issuance and storage in particular UDs and registration of the UDs' instructions regarding selection of permitted forms of EnAEMs;
e) continuous re-calculation by the CCU of numerical value of numerical value of said means is a function of passing time (hereinafter “TDC”) based on a predetermined algorithm including degradation coefficient and transfer cost;
f) continuous re-calculation by the CCU of proportional rights within defined income generating asset pool (hereinafter “IGAPP”) distribution among the UDs;
g) distribution of TDC accrual per IGAPP (hereinafter “TDCAcc”) among the UDs according to IGAPP proportion of each UD;
h) distribution of TDCAcc per IGAPP if and when used as collateral for securing LIG or inter-group advances among UDs;
i) defining the underlying IGAP for TDCAcc generation and transparently displaying said data to all viable UDs via common real-time dashboard or otherwise as requested by the UD; and
j) implementing mandatory distribution of TDCAcc from the IGAP to the EID.

11. The method according to claim 10, wherein as a continuous function of passing time the EID and/or the CCU re-calculates numerical value of TDCs in circulation according to pre-set time-dependant-degradation-coefficient.

12. The method according to claim 10, wherein a total number of EnAEMs generated by the method is a factor of the UDs linked to the system and total numerical value of the IGAP constituents.

13. The method according to wherein the total number of TDCs in circulation at any chosen moment of time is calculated according to the following equation:
X=(N_{UD}*Y)+Z_{exceptions}+(K*Hc) (1)
where
X is the total number of TDCs in circulation,
N_{UD} is a number of the viable UD linked to the system,
Y is a positive integer, and
Z_{exceptions} is a) initial EnAEMs issued before the UDs are operational plus b) allocated reserve EnAEMs according to CDB algorithms, and
K total numerical value of IGAP constituents and He is a coefficient—a positive real number in the range of 0.01 to 2.9.

14. The method according to claim 10, wherein the EnAEMs acquire additional means-forms for UDs to choose in addition to the ones defined herein per merging and accumulating of lesser encrypted or secured protocols and assets.

15. A time degradable currency (TDC) for use in the system according to claim 1 wherein the TDC is a physical TDC comprising a RFID (Radio-frequency identification) or a NFC (Near Field Communication) chip for identification of a time stamp issued by a time stamp generator of the EID.

16. A time degradable currency (TDC) for use in the system according to claim 1 wherein the TDC is printed in physical paper-based form with a time stamp issued by a time stamp generator (TSG) of the EnAEM issuance devi [symbol]
